(19) United States
(12) Patent Application Publication
(10) Pub. No.: US 2009/0172474 A1
(43) Pub. Date: Jul. 2, 2009

(54) Network Diagnostic Systems and Methods for Light Levels of Optical Signals

(75) Inventors: Ricardo A. Negrete, Scotts Valley, CA (US); Genti Cuni, Mountain View, CA (US)

Correspondence Address: Workman Nydegger;1000 Eagle Gate Tower, 60 East South Temple, Salt Lake City, UT, 84111, US

(73) Assignee: VIRTUAL INSTRUMENTS CORPORATION, Scotts Valley, CA (US)

(21) Appl. No.: 12/346,114

(22) Filed: Dec. 30, 2008

Related U.S. Application Data
(60) Provisional application No. 61/018,634, filed on Jan. 2, 2008.

(51) Int. Cl. G06F 11/28; G08B 21/00; G01J 1/42

(52) U.S. Cl. 714/37; 340/540; 356/218

(57) ABSTRACT

A network diagnostic system may include a network diagnostic device. The network diagnostic device may be configured to receive data indicating a light level of an optical signal and to perform at least one network diagnostic function at least partially in response to the receipt of the data. A network diagnostic method may include detecting a light level of an optical signal; and performing at least one network diagnostic function at least partially in response to the detection of the light level of the optical signal. Exemplary network diagnostic functions may include triggering an alarm; triggering a capture of at least a portion of one or more network messages; storing data indicating the light level of the optical signal on a computer readable medium (e.g., for use in subsequent reports); and/or any other suitable network diagnostic function.

### RELATED APPLICATION

This application claims the benefit of U.S. Provisional Patent Application Ser. No. 60/018,634, filed Jan. 2, 2008, which is incorporated herein by reference.

### BACKGROUND OF THE INVENTION

1. Field of the Invention

The present invention generally relates to network diagnostic systems and methods and, in particular, network diagnostic systems and methods for light levels of optical signals.

2. Background Technology

Computer and data communications networks continue to proliferate due to declining costs, increasing performance of computer and networking equipment, and increasing demand for communication bandwidth. Communications networks—including wide area networks (“WANs”), local area networks (“LANs”), metropolitan area networks (“MANs”), and storage area networks (“SANs”)—allow increased productivity and use of distributed computers or stations through the sharing of resources, the transfer of voice and data, and the processing of voice, data and related information at the most efficient locations. Moreover, as organizations have recognized the economic benefits of using communications networks, network applications such as electronic mail, voice and data transfer, host access, and shared and distributed databases are increasingly used as a means to increase user productivity. This increased demand, together with the growing number of distributed computing resources, has resulted in a rapid expansion of the number of installed networks. A variety of network diagnostic systems and methods have been developed to test these networks.

### SUMMARY

One aspect is a network diagnostic system that may include a network diagnostic device. The network diagnostic device may be configured to receive data indicating a light level of an optical signal and to perform at least one network diagnostic function at least partially in response to the receipt of the data. The network diagnostic function may include triggering an alarm; triggering a capture of at least a portion of one or more network messages; storing data indicating the light level of the optical signal on a computer readable medium (e.g., for use in subsequent reports); and/or any other suitable network diagnostic function. In some cases, the light level may be a light level of an optical signal received by a node of a network, for example, a light level of an optical signal received by a receiver of a node. The receiver may, if desired, form part of a transceiver of the node. In some cases, the light level may be a light level of an optical signal received by a switch, such as a physical layer switch or other type of switch. For example, the light level may comprise a light level of an optical signal received by a first switch from a second switch via, for instance, an aggregated inter-switch optical link (such as a trunk link) or other inter-switch optical link. In some cases, the light level may be a light level of an optical signal received from a passive tap. Of course, the light level may be any other light level of an optical signal.

Another aspect is a network diagnostic method that may include detecting a light level of an optical signal; and performing at least one network diagnostic function at least partially in response to the detection of the light level of the optical signal. The network diagnostic function may include triggering an alarm; triggering a capture of at least a portion of one or more network messages; storing data indicating the light level of the optical signal on a computer readable medium (e.g., for use in subsequent reports); and/or any other suitable network diagnostic function. In some cases, the light level may be a light level of an optical signal received by a node of a network, for example, a light level of an optical signal received by a receiver of a node. The receiver may, if desired, form part of a transceiver of the node. In some cases, the light level may be a light level of an optical signal received by a switch, such as a physical layer switch or other type of switch. For example, the light level may comprise a light level of an optical signal received by a first switch from a second switch via, for instance, an aggregated inter-switch optical link (such as a trunk link) or other inter-switch optical link. In some cases, the light level may be a light level of an optical signal received from a passive tap. Of course, the light level may be any other light level of an optical signal.

For purposes of summarizing, some aspects, advantages and features of a few of the embodiments of the invention have been described in this summary. Some embodiments of the invention may include some or all of these summarized aspects, advantages and features. However, not necessarily all of (or any of) these summarized aspects, advantages or features will be embodied in any particular embodiment of the invention. Thus, none of these summarized aspects, advantages and features are essential. Some of these summarized aspects, advantages and features and other aspects, advantages and features may become more fully apparent from the following detailed description and the appended claims.

### BRIEF DESCRIPTION OF THE DRAWINGS

The appended drawings contain figures of preferred embodiments to further clarify the above and other aspects, advantages and features. It will be appreciated that these drawings depict only preferred embodiments of the invention and are not intended to limit its scope. These preferred embodiments will be described and explained with additional specificity and detail through the use of the accompanying drawings in which:

FIG. 1 is a block diagram of an exemplary system;

FIG. 2 is a flowchart illustrating an exemplary method;

FIG. 3 is a flowchart illustrating an exemplary method;

FIG. 4 is a block diagram of an exemplary system;

FIG. 5 is a block diagram of an exemplary system;

FIG. 6 is a block diagram of an exemplary system; and

FIG. 7 is a block diagram of an exemplary system.

### DETAILED DESCRIPTION OF THE PREFERRED EMBODIMENTS

Certain embodiments relate generally to networking systems, including the testing of high speed data transmission systems and components. Embodiments of the invention may be used in other contexts unrelated to testing systems and components and/or in other contexts unrelated to high speed data transmission.

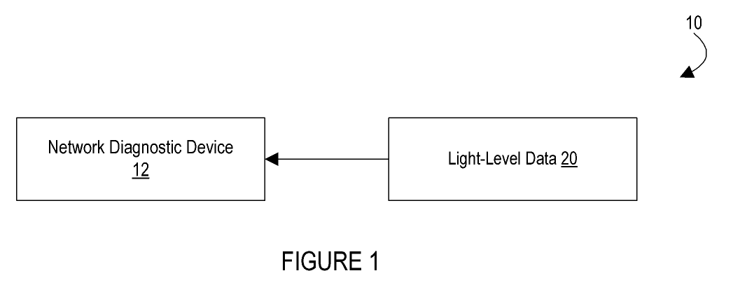

The networking system 10 shown in FIG. 1 may comprise a network, a network diagnostic system, and/or any other suitable networking system. The networking system 10 may include one or more nodes. As used herein, a “node” includes, but is not limited to, a server or host; a client or storage device; a switch (such as a physical layer switch or other type of switch); a hub; a router; all or a portion of a SAN fabric; a diagnostic device; and any device that may be coupled to a network and that may receive and/or monitor a signal or data over at least a portion of a network, that may send and/or generate a signal or data over at least a portion of a network, or both.

The nodes may use a signal (such as, an optical signal) to send and/or receive network messages over at least a portion of the networking system 10. As used herein, a “network message” includes, but is not limited to, a packet; a datagram; a frame; a data frame; a command frame; an ordered set; any unit of data capable of being routed (or otherwise transmitted) through a network; and the like. In one embodiment, a network message may comprise transmission characters used for data purposes, protocol management purposes, code violation errors, and the like. Also, an ordered set may include, a Start of Frame (“SOF”), an End of Frame (“EOF”), an Idle, a Receiver_Ready (“R_RDY”), a Loop Initialization Primitive (“LIP”), an Arbitrate (“ARB”), an Open (“OPN”), and Close (“CLS”)—such as, those used in certain versions of Fibre Channel. Of course, any ordered sets and/or any network messages of any other size, type, configuration and/or protocol may be used.

The nodes may communicate using any suitable network protocol, including, but not limited to, serial protocols, physical layer protocols, channel protocols, packet-switching protocols, circuit-switching protocols, Ethernet, Fast Ethernet, Gigabit Ethernet, 10 Gigabit Ethernet, Fibre Channel, Fibre Channel Arbitrated Loop (“FC-AL”), Small Computer System Interface (“SCSI”), High Performance Parallel Interface (“HIPPI”), Serial Attached SCSI (“SAS”), Serial ATA (“SATA”), SAS/SATA, Serial SCSI Architecture (“SSA”), and the like.

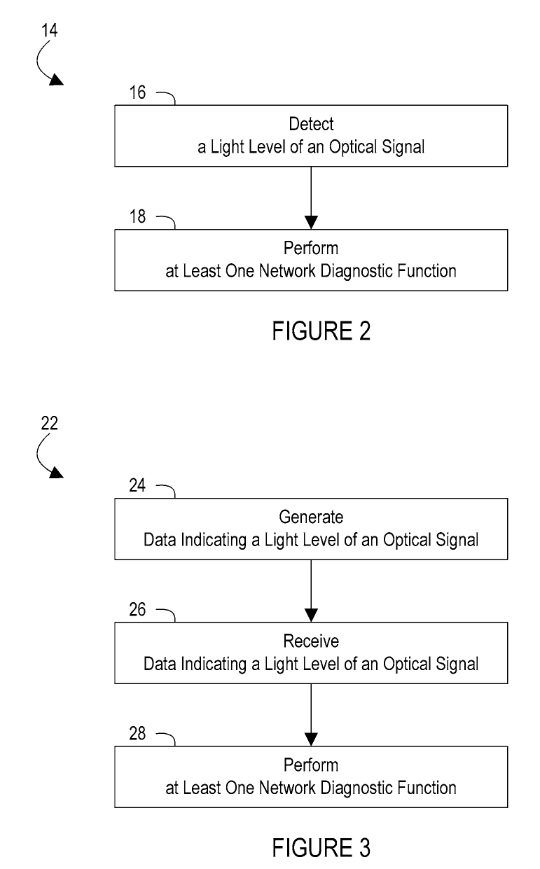

As shown in FIG. 1, the networking system 10 may include a network diagnostic device 12 that may be configured to test the communication between the nodes. For example, the network diagnostic device 12 and/or one or more other components of the networking system 10 may be configured to perform all or at least a portion of a network diagnostic method 14 shown in FIG. 2. In particular, the network diagnostic device 12 and/or one or more other components of the networking system 10 may, at block 16, detect a light level of an optical signal and may, at block 18, perform at least one network diagnostic function at least partially in response to the detection of the light level of the optical signal at block 16.

For example, with reference to FIGS. 1 and 3, the network diagnostic device 12 may perform at least one network diagnostic function at least partially in response to receiving light-level data 20. For instance, as shown in a network diagnostic method 22 of FIG. 3, data indicating a light level of an optical signal may be generated at block 24 and may be received by the network diagnostic device 12 at block 26. And the network diagnostic device 12 may, at block 28, perform at least one network diagnostic function at least partially in response to receiving the data.

Exemplary network diagnostic functions performed at the blocks 18 and 28 may include, but are not limited to, triggering an alarm; triggering a capture of at least a portion of one or more network messages; storing data indicating the light level of the optical signal on a computer readable medium (e.g., for use in subsequent reports)—for instance in a database; and/or other suitable network diagnostic functions.

In some cases, the light level detected at the block 16 and/or the light level indicated by the data at blocks 24, 26 may be a light level of an optical signal received by a node of a network, for example, a light level of an optical signal received by a receiver of a node of the networking system 10. The receiver may, if desired, form part of a transceiver of the node. In some cases, the light level detected at the block 16 and/or the light level indicated by the data at blocks 24, 26 may be a light level of an optical signal received by a switch, such as a physical layer switch or other type of switch. For example, the light level may comprise a light level of an optical signal received by a first switch from a second switch via, for instance, an aggregated inter-switch optical link (such as a trunk link) or other inter-switch optical link. In some cases, the light level detected at the block 16 and/or the light level indicated by the data at blocks 24, 26 may be a light level of an optical signal received from a passive tap. Of course, the light level detected at the block 16 and/or the light level indicated by the data at blocks 24, 26 may be any other light level of an optical signal.

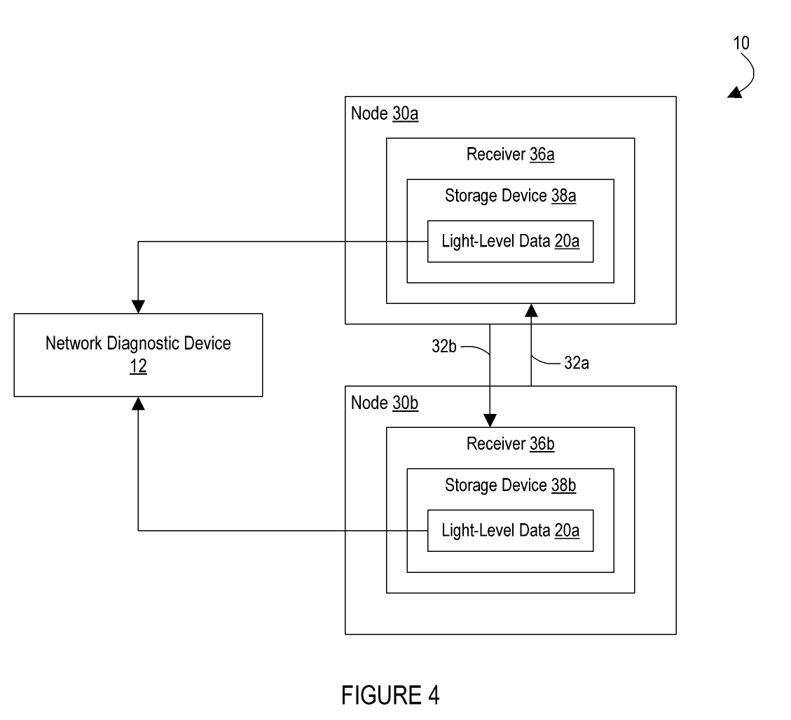

As shown in FIG. 4, the networking system 10 may include a plurality of nodes, such as nodes 30a, 30b. The nodes 30a, 30b may be configured to send and receive network messages to each other via one or more signals. For example, the node 30a may send one or more network messages to the node 30b via an optical signal 32b, and the node 30b may send one or more network messages to the node 30a via an optical signal 32a. As shown in FIG. 4, receivers 36a, 36b of the nodes 30a, 30b may receive the optical signals 32a, 32b, respectively. When a receiver 36a, 36b receives an optical signal 32a, 32b, the receiver 36a, 36b may detect the light level of the received optical signal 32a, 32b; may generate light-level data 20a, 20b indicating the detected light level; and may store the light-level data 20a, 20b in a storage device 38a, 38b of the receiver 36a, 36b. The network diagnostic device 12 may directly or indirectly receive the light-level data 20a, 20b from the receivers 36a, 36b and may perform at least one network diagnostic function at least partially in response to receiving the light-level data 20a, 20b.

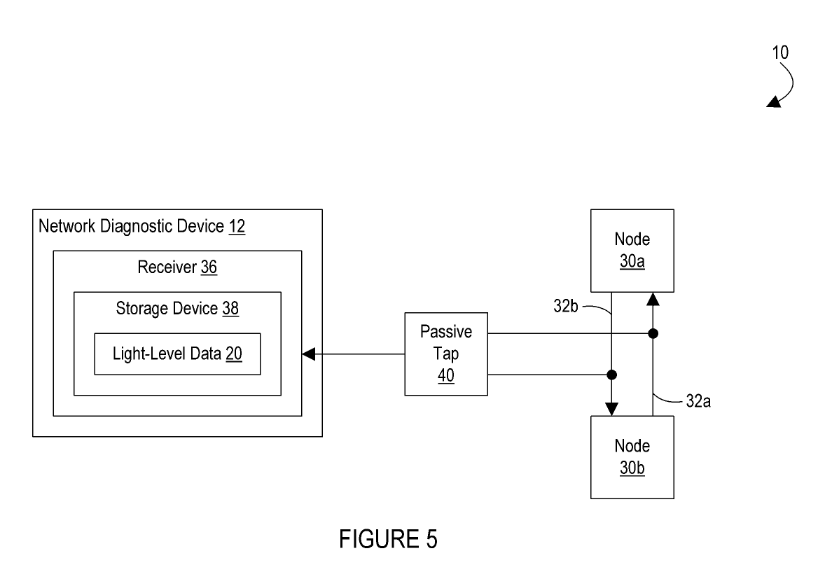

As shown in FIG. 5, nodes 30a, 30b may be configured to send and receive network messages to each other via one or more signals 32a, 32b, and a passive tap 40 may be configured to send a portion of any of the optical signals 32a, 32b to the network diagnostic device 12. The network diagnostic device 12 may include a receiver 36, which may receive the portion of the optical signal 32a, 32b. The receiver 36 of the network diagnostic device 12 may, if desired, form part of a transceiver. When the receiver 36 of the network diagnostic device 12 receives the portion of the optical signal 32a, 32b, the receiver 36 may detect light levels of the received portion of the optical signal 32a, 32b; may generate light-level data 20 indicating the detected light level; and may store the light-level data 20 in a storage device 38 of the receiver 36. The network diagnostic device 12 may receive the light-level data 20 from the receiver 36 and may perform at least one network diagnostic function at least partially in response to receiving the light-level data 20.

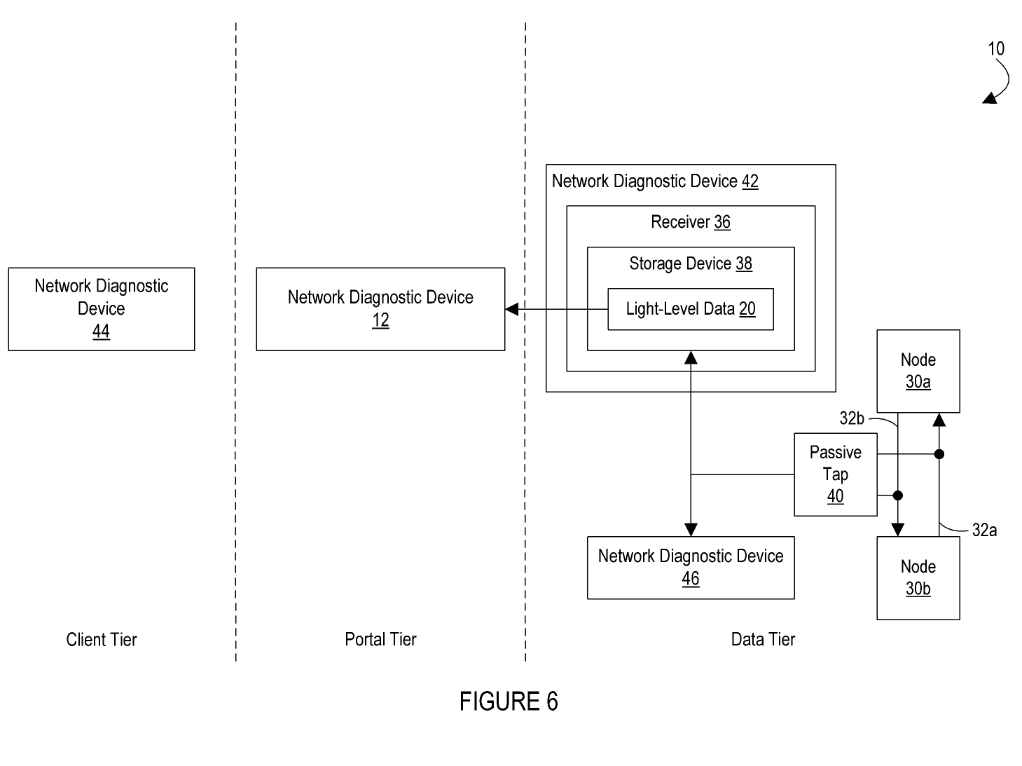

As shown in FIG. 6, nodes 30a, 30b may be configured to send and receive network messages to each other via one or more signals 32a, 32b, and a passive tap 40 may be configured to send a portion of any of the optical signals 32a, 32b to a network diagnostic device 42. The network diagnostic device 42 may include a receiver 36, which may receive the portion of the optical signal 32a, 32b. The receiver 36 of the network diagnostic device 42 may, if desired, form part of a transceiver. When the receiver 36 of the network diagnostic device 42 receives the portion of the optical signal 32a, 32b, the receiver 36 may detect light levels of the received portion of the optical signal 32a, 32b; may generate light-level data 20 indicating the detected light level; and may store the light-level data 20 in a storage device 38 of the receiver 36. The network diagnostic device 42 may send the light-level data 20 to the network diagnostic device 12, which may perform at least one network diagnostic function at least partially in response to receiving the light-level data 20.

In some embodiments, the network diagnostic devices 12, 42 and/or other aspects of the networking system 10 may be embodied as part of a multi-tiered distributed system. For example, three tiers (a data source tier, a portal tier and a client tier) are illustrated in FIG. 6.

In further detail, the data source tier may be a functional component that monitors the physical data present on a network medium. The data source tier preferably includes one or more network diagnostic devices 42. The network diagnostic devices 42 may monitor the physical data present on the network medium and, in a preferred embodiment, may generate discrete intervals of data. The network diagnostic devices 42 may then analyze these data intervals and identify specific “attributes” of the network data. These attributes can be certain characteristic or statistic information that relates to the monitored network data. These attributes are preferably generated in the form of “metrics,” which are discrete data units. For example, in a SAN environment, a metric may be “storage I/O” centric and may contain attributes of multi-interval storage I/O transactions between devices on the network. In addition, the metrics may contain attributes of instantaneous events that may occur on the network. If desired, the network diagnostic devices 42 may generate these metrics in substantially real time and thus may be able to continuously generate metrics from the network traffic as fast as the traffic occurs within the network.

After generating these metrics, the network diagnostic devices 42 may forward the metrics to the portal tier. The portal tier is preferably implemented using the network diagnostic device 12, which may comprise a host computing device running software. The portal tier generally provides the function of collection, management and reformatting of the metric data collected from the network diagnostic devices 42. In preferred embodiments, the portal tier may manage the metric data by encapsulating metric data received from a network diagnostic device 42 into a data structure referred to as a “data container.” This data container may have a predefined format and may organize the metric data in accordance with the type of attributes contained in the metrics.

Once generated at the portal tier, data containers may be requested by the client tier. The client tier is preferably implemented using a network diagnostic device 44, which may comprise a host computing device running software. The client tier preferably provides a user interface that can be used by a user to selectively display various types of network information that is derived from the contents of data containers that are received from the portal tier. Preferably, the interface is a graphics-based interface, which allows a variety of graphical views of different network operating characteristics. In one embodiment, the set of alarm conditions associated with a particular alarm may be user-specified via a user interface of the network diagnostic device 44.

As mentioned above with reference to FIG. 6, the network diagnostic device 12 may perform at least one network diagnostic function at least partially in response to receiving the light-level data 20 from the network diagnostic device 42. For example, the user interface of the network diagnostic device 44 may be used to configure the network diagnostic device 12 to trigger an alarm at least partially in response to the network diagnostic device 12 receiving light-level data 20 indicating a sufficiently low light level of an optical signal (such as, a sufficiently low light level of the portion of the optical signal 32a, 32b received by the receiver 36 of the network diagnostic device 42 from the passive tap 40). Also, the user interface of the network diagnostic device 44 may be used to configure the network diagnostic device 12 to—at least partially in response to the network diagnostic device 12 receiving light-level data 20 indicating a sufficiently low light level of an optical signal—trigger a network diagnostic device 46 to a capture at least a portion of one or more network messages. In addition, the user interface of the network diagnostic device 44 may be used to configure the network diagnostic device 12 to—at least partially in response to the network diagnostic device 12 receiving light-level data 20 indicating a sufficiently low light level of an optical signal—store data indicating the light level of the optical signal on a computer readable medium of the network diagnostic device 12 (e.g., for use in subsequent reports), for instance in a database.

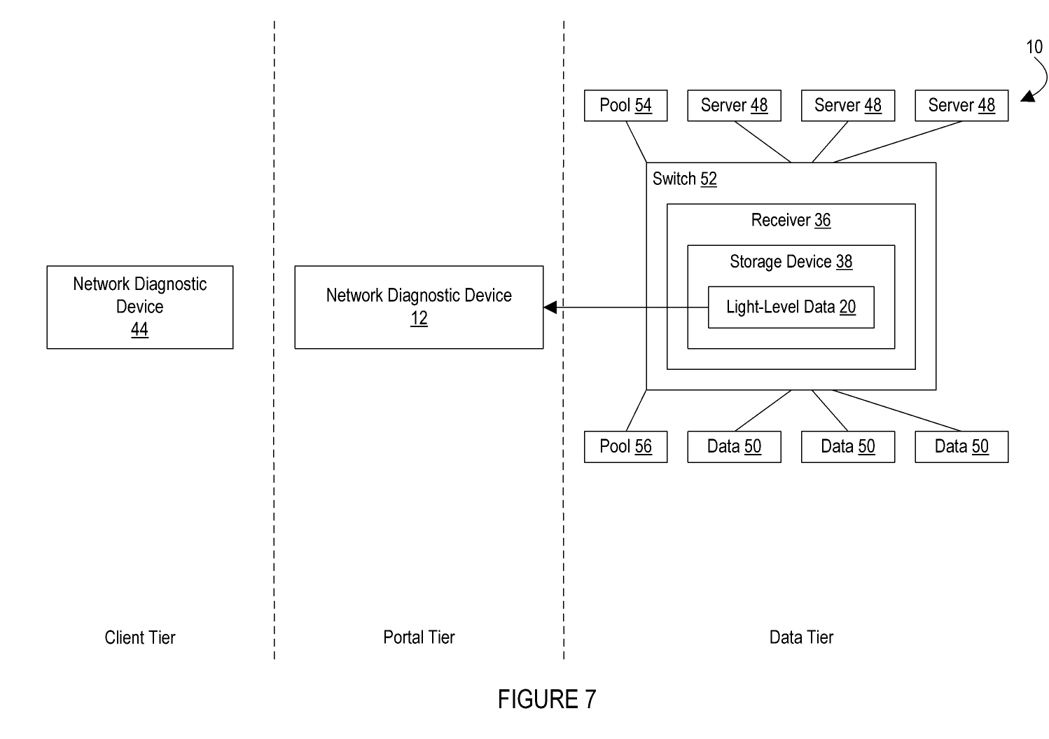

The multi-tiered distributed system shown in FIG. 6 may include a variety of other suitable components and/or configurations. For example, as shown in FIG. 7, the data tier may include a plurality of nodes (such as servers 48 and data sources 50) that may be connected to a switch 52, which may interconnect the nodes and which may be physical layer switch or other suitable switch. The switch 52 may include a plurality of ports; and the nodes may be coupled to the ports and may send and/or receive communication via the ports. The switch 52 may link a plurality of ports to enable communication among the nodes connected to the ports, and the switch 52 may unlink the ports to disable that communication. The switch 52 may copy and send (or repeat) the communication among a plurality of ports to at least one other port. The switch 52 preferably includes a software interface or other interface via which this linking, unlinking, and this copying may be configured and/or otherwise controlled by other software and/or hardware components. Thus, if desired, the switch 52 may have software-programmable linking of ports, software-programmable unlinking or ports, and/or software-programmable copying (or repeating) of communication.

Some or all of the ports of the switch 52 may include a receiver 36, which may receive an optical signal from a node, such as a server 48 or a data source 50. The receiver 36 of the port may, if desired, form part of a transceiver. When the receiver 36 of the port receives the optical signal from the node, the receiver 36 may detect light levels of the received optical signal; may generate light-level data 20 indicating the detected light level; and may store the light-level data 20 in a storage device 38 of the receiver 36. As shown in FIG. 7, the switch 52 may send the light-level data 20 to the network diagnostic device 12, which may perform at least one network diagnostic function at least partially in response to receiving the light-level data 20.

As shown in FIG. 7, the data tier may also include one or more pools 54 of network diagonstic devices 42, which may be connected to the switch 52. A member of the pool 54 may be configured to test a set of one or more links of the switch 52. For example, one member of the pool 54 may be configured to test single link, and another member of the pool 54 may test a plurality of links. When testing a plurality of links, a member of the pool 54 is preferably configured to move (or “rove”) from one link to another link. Roving may advantageously allow the member to test each of a plurality of links—albeit for a percentage of the time. The member may be configured to rove from link to link at generally regular intervals to allow each link to be tested a generally equal amount of time; however, the member may be configured to rove from link to link at substantially different intervals to allow different links to be tested substantially different amounts of time depending, for example, upon the importance of the particular link. In addition, the members of pool 54 may be allocated to test differently sized sets of links depending, for example, upon the importance of the particular links. For example, one member of the pool may be configured to rove among a relatively large set of less important links; and another member of the pool may be configured to rove among a relatively small set of more important links (or even test a single link). It will be appreciated, however, that the members of the pool may be configured to test the same sized sets of links, if desired.

If desired, the data tier may include a first pool 54 including one or more network diagonstic devices 42 and a second pool 56 including one or more network diagonstic devices 42 and/or one or more network diagnostic devices 46. One or more members of the second pool 56 may be configured to test a link. For example, the one or more members of the second pool 56 may—at least partially in response to a member of the first pool 54 detecting particular conditions on a first link—be configured to test the first link. This condition-triggered configuration of the second pool 56 may allow the one or more members of the second pool 56 to troubleshoot the first link by performing additional network diagnostic functions. If desired, the member of the first pool 54 may be configured to continue to rove from the first link to a second link without waiting for the one or more members of the second pool 56 to finish troubleshooting the first link. Accordingly, because the member of the first pool 54 may test the second link, one or more members of the second pool 56 may—at least partially in response to the roving member detecting particular conditions on the second link—be configured to test the second link, even while troubleshooting continues on the first link, if desired. In one embodiment, because the second pool 56 may have a limited number of members, the members of the second pool may be configured to test links according to priority. Other details regarding pools of network diagnostic devices are disclosed in Assignee's co-pending U.S. patent application Ser. No. 11/560,247, filed Nov. 15, 2006 and entitled POOL-BASED NETWORK DIAGNOSTIC SYSTEMS AND METHODS.

The methods and systems described above require no particular component or function. Thus, any described component or function—despite its advantages—is optional. Also, some or all of the described components and functions described above may be used in connection with any number of other suitable components and functions.

Although this invention has been described in terms of certain preferred embodiments, other embodiments apparent to those of ordinary skill in the art are also within the scope of this invention. Accordingly, the scope of the invention is intended to be defined only by the claims which follow.

What is claimed is:

1. A network diagnostic system comprising:
a network diagnostic device configured to receive first data indicating a light level of an optical signal and to perform at least one network diagnostic function at least partially in response to the receipt of the first data.

2. The network diagnostic system as in claim 1, wherein the at least one network diagnostic function comprises triggering an alarm.

3. The network diagnostic system as in claim 1, wherein the at least one network diagnostic function comprises triggering a capture of at least a portion of a network message.

4. The network diagnostic system as in claim 1, wherein the at least one network diagnostic function comprises triggering a capture of at least a portion of each of a plurality of a network messages.

5. The network diagnostic system as in claim 1, wherein the at least one network diagnostic function comprises storing second data indicating the light level of the optical signal on a computer readable medium.

6. The network diagnostic system as in claim 1, wherein the at least one network diagnostic function comprises storing second data indicating the light level of the optical signal in a database.

7. The network diagnostic system as in claim 1, wherein the light level of the optical signal comprises a light level of an optical signal received by a node of a network.

8. The network diagnostic system as in claim 1, wherein the light level of the optical signal comprises a light level of an optical signal received by a receiver of a node of a network.

9. The network diagnostic system as in claim 1, wherein the light level of the optical signal comprises a light level of an optical signal received by a switch.

10. The network diagnostic system as in claim 1, wherein the light level of the optical signal comprises a light level of an optical signal received by a physical layer switch.

11. The network diagnostic system as in claim 1, wherein the light level of the optical signal comprises a light level of an optical signal received by a first switch from a second switch.

12. The network diagnostic system as in claim 1, wherein the light level of the optical signal comprises a light level of an optical signal received from a passive tap.

13. A network diagnostic method comprising:
detecting a light level of an optical signal; and
performing at least one network diagnostic function at least partially in response to the detection of the light level of the optical signal.

14. The network diagnostic method as in claim 13, wherein the at least one network diagnostic function comprises triggering an alarm.

15. The network diagnostic method as in claim 13, wherein the at least one network diagnostic function comprises triggering a capture of at least a portion of a network message.

16. The network diagnostic method as in claim 13, wherein the at least one network diagnostic function comprises triggering a capture of at least a portion of each of a plurality of a network messages.

17. The network diagnostic method as in claim 13, wherein the at least one network diagnostic function comprises storing data indicating the light level of the optical signal on a computer readable medium.

18. The network diagnostic method as in claim 13, wherein the at least one network diagnostic function comprises storing data indicating the light level of the optical signal in a database.

19. The network diagnostic method as in claim 13, wherein the light level of the optical signal comprises a light level of an optical signal received by a node of a network.

20. The network diagnostic method as in claim 13, wherein the light level of the optical signal comprises a light level of an optical signal received by a receiver of a node of a network.

21. The network diagnostic method as in claim 13, wherein the light level of the optical signal comprises a light level of an optical signal received by a switch.

22. The network diagnostic method as in claim 13, wherein the light level of the optical signal comprises a light level of an optical signal received by a physical layer switch.

23. The network diagnostic method as in claim 13, wherein the light level of the optical signal comprises a light level of an optical signal received by a first switch from a second switch.

24. The network diagnostic method as in claim 13, wherein the light level of the optical signal comprises a light level of an optical signal received from a passive tap.
